(19) United States
(12) Patent Application Publication
(10) Pub. No.: US 2023/0342827 A1
(43) Pub. Date: Oct. 26, 2023

(54) BILLING FOR SUCCESSFUL IVF TREATMENT

(71) Applicant: Dmitri Dozortsev, Houston, TX (US)

(72) Inventor: Dmitri Dozortsev, Houston, TX (US)

(21) Appl. No.: 17/880,327

(22) Filed: Aug. 3, 2022

Related U.S. Application Data
(60) Provisional application No. 63/333,399, filed on Apr. 21, 2022.

(51) Int. Cl. G06Q 30/04; G06Q 30/0283

(52) U.S. Cl. CPC G06Q 30/04; G06Q 30/0283

(57) ABSTRACT

An approach is disclosed for billing in vitro fertilization services (IVFS) based on successful outcome. A cost of the IVFS per single successful outcome is calculated. A cost of providing said IVFS to a plurality of clients with predefined parameters over a period of time is calculated. A target profit margin for providing said IVFS to said plurality of clients is identified. A price to be charged only to clients achieving said successful outcome from the said plurality of clients in order to attain said target profit margin is calculated. A contract for said IVFS is offered by said provider to a potential client with payment only due on achievement of said successful outcome based on said price. Responsive to receiving an acceptance of said contract from said potential client, providing said IVFS to said potential client as a new client based on said contract.

If an Application Data Sheet (ADS) has been filed for this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority from U.S. Provisional Pat. Application No. 63333,399 filed on Apr. 21, 2022

### BACKGROUND

The present invention relates to the field of infertility treatment, specifically to the increasing the transparency of pricing for IVF services.

### SUMMARY

According to one embodiment of the invention, there is provided a method for billing in vitro fertilization services (IVFS) based on successful outcome. A cost of the IVFS per single successful outcome is calculated. A cost of providing said IVFS to a plurality of clients with predefined parameters over a period of time is calculated. A target profit margin for providing said IVFS to said plurality of clients is identified. A price to be charged only to clients achieving said successful outcome from the said plurality of clients in order to attain said target profit margin is calculated. An application from a potential client with said predefined parameters is received by said provider. A contract for said IVFS is offered by said provider to said potential client with payment only due on achievement of said successful outcome based on said price. Responsive to receiving an acceptance of said contract from said potential client, providing said IVFS to said potential client as a new client based on said contract.

According to one embodiment of the invention, there is provided a method implemented by a processor executing instructions having the steps of the method for billing IVFS based on successful outcome.

According to one embodiment of the invention, there is provided a computing program product executing instructions having the steps of the method for billing IVFS based on successful outcome.

According to one embodiment of the invention, there is provided an information handling system including at least one processor executing instructions implementing steps of the method for billing IVFS based on successful outcome.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a payment options comparison study;

FIG. 2 depicts a provider options comparison study;

FIG. 3 depicts an IVF offering analysis embodiment 1;

FIG. 4 depicts an IVF invoicing process when price for treatment contracted;

FIG. 5 depicts an IVF offering analysis embodiment 2;

FIG. 6 depicts an IVF offering embodiment 3;

FIG. 7 depicts example IVF expected outcome parameters;

FIG. 8 depicts IVF AI cost analysis based on success payments; and

FIG. 9 depicts a schematic view of a processing system wherein the methods of this invention may be implemented.

### DETAILED DESCRIPTION

In medicine, a typical desirable outcome is an incremental improvement that cannot be easily quantified. Therefore, patients are billed for services rendered. Outcome-based payment models are only applicable to incentivizing providers by insurance carriers and are always very limited in scope.

Uniquely for medicine, the outcome of In vitro fertilization (IVF) is binary - client has a child at the end of the process, or no child. This enables IVF clinics to market themselves by their success rate or in other words by client’s chances to become pregnant under their care.

However, without some type of validation it is impossible to ascertain whether the claimed success rate was reported truthfully. Since the chance of pregnancy is the main criteria by which clients chooses a place for IVF, marketing pressure often forced providers to inflate their success rates. As the result, some of IVF providers were complaining about unfair competitive practices and were pointing out that this would amount to false advertisement.

In order to make IVF care outcomes more transparent and comparable between clinics, after years of heated debates, in 1992 the US congress passed a law requiring IVF treatment providers to report their outcomes to the Center for Disease Control and Prevention (CDC), following a rigid criterion that made outcome misrepresentation difficult. This greatly improved reporting accuracy, enabling clients to make better choices of the IVF provider.

However, after several years it became clear that such approach is not fool proof. For example, larger IVF clinics could afford to turn away unfavorable prognosis clients (i.e. low ovarian reserve), placing smaller clinics at a unfair disadvantage. Or, a client with low ovarian reserve would be recommended egg donation before she fully explored her chances to become pregnant with her own eggs. Also, some providers could allocate poor prognosis clients into various sometime dubious research protocols not covered by the reporting requirements.

Furthermore, some IVF providers would artificially increase their success rates by transferring more embryos. This improves chances of pregnancy, but also worsens morbidity for both, mothers and children. Prospective parents, struggling with infertility may not have the capacity to appreciate (octomom is a well-known case in point).

These and other practices artificially inflating the rate of success and are not easily apparent for a non-sophisticated individual. Also, the interpretation of the outcome’s tables maybe challenging to interpret not only for the clients but sometimes even for a professional.

The next step in assuring clients in outcomes became so-called “outcome guarantee programs.” Client enrolled into such program would receive a refund if after certain number of attempts a child is not born. However, receiving the money back is not a straightforward process and the client is usually still responsible for a considerable portion of the cost (i.e. drugs etc.). Also, there are always some additional billable services not covered by guarantee. Furthermore, while clinic holds the payment during treatment, even if it is partially refunded at the end, these funds do not generate any interest for the client.

To summarize, current IVF billing models require clients to share a considerable financial risk, which is not fully compensated even if a positive outcome is not achieved. In order to overcome the deficiencies of the prior art, the disclosed business method revolutionizes IVF industry by offering a simple and transparent algorithm which frees clients who do not achieve positive outcome from any financial risk.

In an embodiment of the disclosed business method, IVF service is offered without upfront payment by client and furthermore no payment is due until and unless the childbirth, or another pre-agreed positive outcome has taken place. The disclosed business method creates an extraordinary medicine value proposition: no out-of-pocket expenses until and unless an unambiguously positive outcome is achieved.

Since no payment is due until client has a child for anything, the physician is not incentivized to order any billable services, unless the service directly improves the chance of pregnancy. This results in the following benefits: 1. physician’s time (the most expensive component of IVF service) is focused on the essential ways to improve the chance of pregnancy, 2. reduces cost-basis of IVF treatment per-client and 3. allows a physician to serve more clients.

Reducing the cost of IVF per client and passing saving on to other clients, reduces the price of IVF for everyone, making IVF affordable for more clients. In fact, according to estimates, hidden IVF market is at least equal to the current market, but remains unexplored due to the cost. Furthermore, the disclosed business method will be very attractive to health insurance carriers, who will be more open to offer IVF benefits to its clients further expanding the availability of IVF services.

The disclosed business model’s transparency can be further strengthened by limiting the number of transferred embryos to 1 in all cases. In such model, not only does the client avoid financial risk, but also the multiple pregnancy risk is reduced to the minimum, client billing abuse becomes counterproductive to the bottom line and a full public trust is restored without the need for any reporting or audits.

It is estimated that eliminating billable services not directly leading to positive outcome will increase the number of clients serviceable by a single physician from 200 to 1000. This is why, even though each client with successful outcome will pay for clients who did not have successful outcome, the estimated price client will pay is less than an average price for IVF in the legacy business IVF services model.

Reducing the cost of IVF per client and passing saving on to other clients, reduces the price of IVF for everyone, making IVF affordable for more clients.

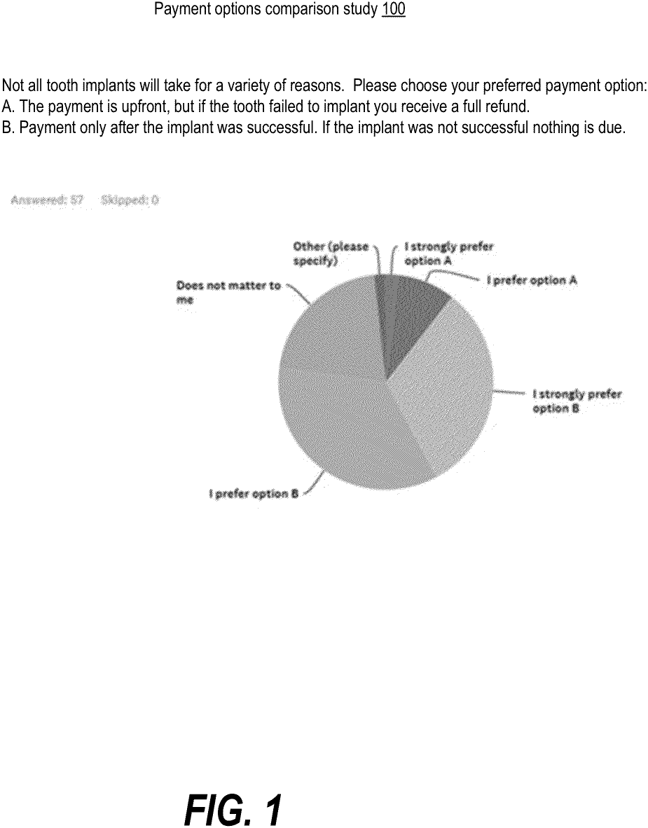

FIG. 1 depicts a payment options comparison study 100. A survey was to taken to test a basis for utilizing the disclosed methodology. For the survey purposes tooth implants were used as an example, since more people have experience with this procedure than with IVF. The cost of dental implants is in the same ballpark as IVF and the outcome is generally also binary. The survey stated: “Not all tooth implants will take for a variety of reasons. Please choose your preferred payment option:

A. The payment is upfront, but if the tooth failed to implant you receive a full refund.

B. Payment only after the implant was successful. If the implant was not successful nothing is due.”

The survey demonstrated that while some clients do like an idea of reimbursement, they prefer the concept of no payment until the successful outcome is achieved by an 85% margin.

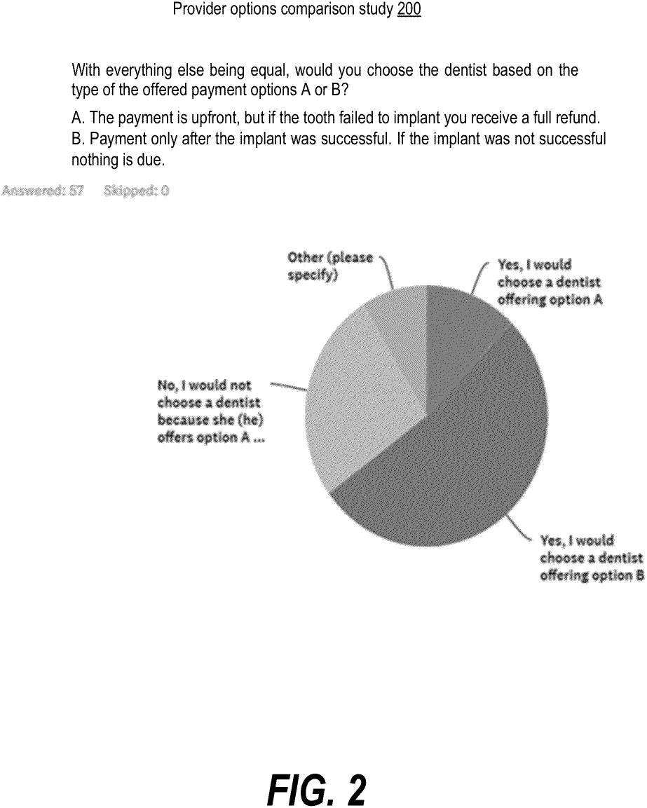

FIG. 2 depicts a provider options comparison study 200. The survey stated: “With everything else being equal, would you choose the dentist based on the type of the offered payment options A and B?”

A. The payment is upfront, but if the tooth failed to implant you receive a full refund.

B. Payment only after the implant was successful. If the implant was not successful nothing is due.”

In line with the answer above, the type of billing method disclosed would determine the choice of the clinic by clients.

In an embodiment, in order to enforce payment by those clients who achieve a desirable outcome, all clients accepted into the program would be prequalified (i.e. based on their credit score) and would sign an agreement stipulating that should they decide to stop treatment without a medically justifiable reason, the payment becomes due. It also requires clients to be available so that IVF provider can verify the outcome. If client refuses to disclose the outcome, the payment becomes due.

According to an embodiment, clients may be required pay a small initiation fee upfront, that can optionally be refunded. Optionally, within the context of the disclosed business model, clients may be signing financial agreement with a third party, instead of with the provider. In an embodiment, once the payment is due, a client may choose to finance it with that third party. The third party may also have an agreement with the IVF provider to advance payment for treatment to the provider before the outcome is known. This payment may be refunded by the IVF provider to the third party with interest in case the positive outcome is not achieved. Alternatively, clients may prefer to prepay for a successful outcome prior to completing IVF treatment and receive a complete refund if the outcome is not successful.

In an embodiment, the method provides support for terminating treatment at any point, if it appears that the chance of a desirable outcome is too low to continue expenditure of the resources by provider.

Initially, success rate calculations would use historical data. However, once IVF services are being provided, the disclosed method may utilize artificial intelligence (AI) for continued calculation of the probability of a favorable outcome to determine the new cost as the number of clients enrolled into the program increases.

Once in operations, the success rates may be continually adjusted based on the outcomes achieved. Success rates is defined as a percentage or probability (expressed as a percentage). This percentage can refer to: 1. Percentage of clients achieving successful outcome (per provider) over a period of time 2. Probability of a given client to achieve a successful outcome.

In an example scenario, 3 clients out 10 will achieve successful outcome and the cost of providing service for 10 clients is $1,000. The cost distributed between 3 clients is $1000/3 = $333. $333 is the cost of achieving one successful outcome. The predetermined profit margin is, for example, 40%. The price per client with successful outcome $333 × 1.4 = $466. In this example scenario a contract is written for the client to pay $466 when an agreed to outcome is achieved. The contract may have a clause allowing a provider of the IVFS to cancel the vitro fertilization services at any time. The contract may also have a clause where the said payment becomes due before outcome is known if client decides to stop receiving IVFS after the service has been started for any other reasons than health related. The costs may include all costs, including medication and services provided by third parties. The outcome prediction analysis may utilize female parameter and male parameters against a database of prior infertility cases to predict the probability of the successful outcome. The costs may be calculated from the outcome prediction analysis. The successful outcome may require embryo testing for genetic or metabolic competency. The outcome prediction analysis may utilize an artificial intelligence (AI) learning algorithm trained on data received from a plurality of case histories. The method may construct an expense versus predicted income algorithm timeline where the expense versus predicted income algorithm timeline is used to determine the price to charge clients based on predicted cost. The expense versus predicted income algorithm timeline may be used to determine the payment plan. The method may apply a statistical algorithm to determine a minimum number of clients receiving IVFS in a period of time required to maintain an expected child delivery rate. The method may calculate a total expense to provide the IVFS to the minimum number of clients in the period of time. From that total price, a price to charge per client to only clients achieving successful delivery of a child is calculated to cover the total expense. Those clients with the successful outcome are invoiced with at least the calculated price to charge per client. The invoicing may be after an established period of time, for example, 9 months. The client may be, for example, but not limited to, an individual, a couple, an entity, such as insurance carrier, a third-party agency, and the like.

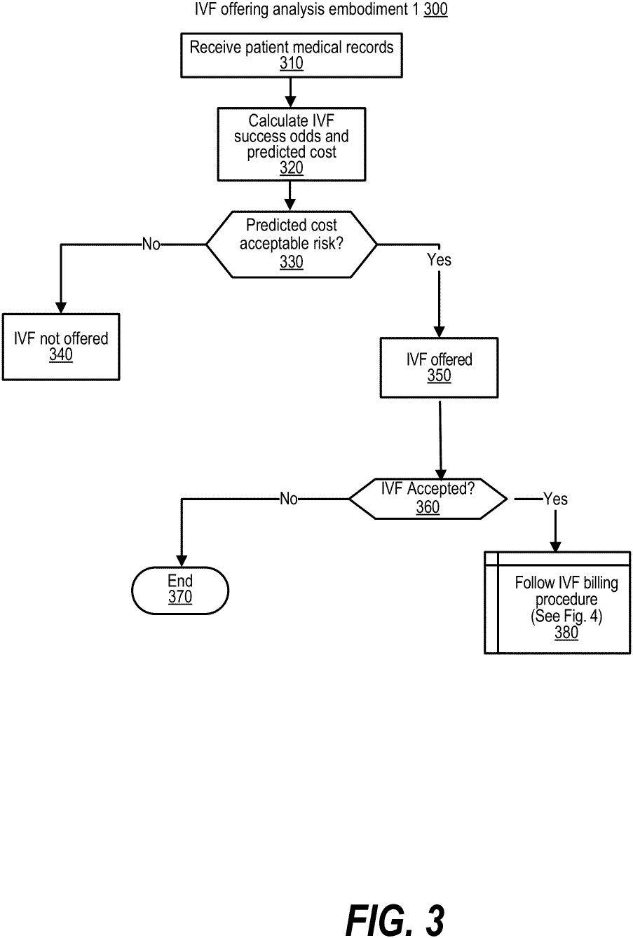

FIG. 3 depicts an IVF offering analysis embodiment 1 300. At step 310, the process receives client medical records. In one embodiment, the information may be received as results from lab tests ordered by the facility trying to predict costs. In another embodiment, data may be received by importing health records from previously taken lab tests. At step 320, the process calculates IVF success odds and predicted cost. The costs may be, for example, for the cost of IVFS per successful outcome. The client parameters include gamete sources and intended pregnancy carrier. The successful outcome may be one or more conditions, such as, but not limited to a positive Human Chorionic Gonadotropin (hCG) test, fetal heart beat, 3 months or more into a pregnancy, delivery of a child, delivery of a healthy child, and the like. In an embodiment, one of the critical factors, such as, for example, but not limited to age of egg donor being over 45 may imply an unacceptable risk base on the cost of IVFS per successful outcome. In an embodiment, a probability of IVFs per successful outcome may be calculated for a specific subset of client parameters based on, for example, but not limited to age, Body mass index (BMI), Anti-Mullerian Hormone (AMH), number of prior unsuccessful IVFs, uterine status, cycle duration, and baseline follicular count, co-morbidities, sperm characteristics, and carrier demography, and the like. The price of IVFS per successful outcome may be calculated for a specific subset of client parameters based on the calculated probability of a successful outcome. In an embodiment, the client may not be a source of gametes or a pregnancy carrier where the source of gametes for IVFS are donors and a surrogate is used for the IVFS. The IVFS service may be an IVF, oocyte donation or third party reproduction or gender selection.

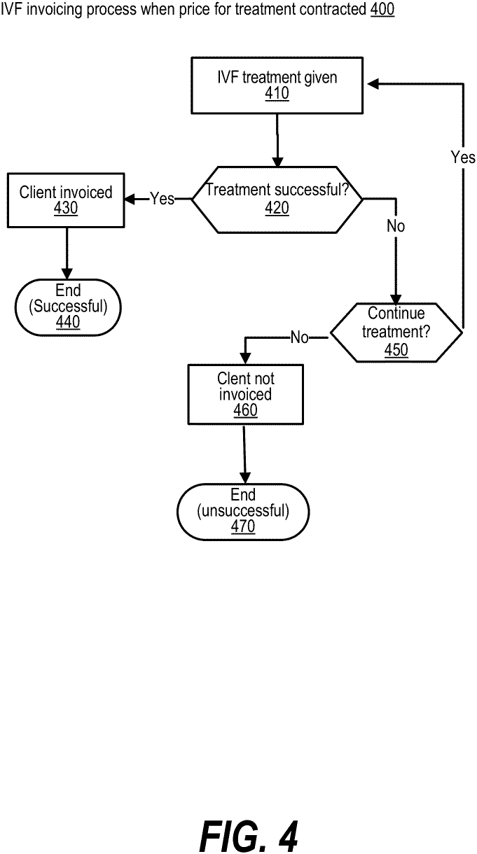

The process determines as to whether predicted cost acceptable risk (decision 330). If predicted cost acceptable risk, then decision 330 branches to the ‘yes’ branch. On the other hand, if not predicted cost acceptable risk, then decision 330 branches to the ‘no’ branch. At step 340, the IVF is not offered. At step 350, the IVF is offered. The process determines as to whether IVF accepted (decision 360). If IVF accepted, then decision 360 branches to the ‘yes’ branch. On the other hand, if not IVF accepted, then decision 360 branches to the ‘no’ branch. FIG. 3 processing thereafter ends at 370. At predefined process 380, the process performs the follow IVF billing procedure routine (see FIG. 4 and corresponding text for processing details).

FIG. 4 depicts an IVF invoicing process when price for treatment contracted 400. At step 410, an IVF treatment is given. After some period of time, the process determines as to whether treatment successful (decision 420). If treatment successful, then decision 420 branches to the ‘yes’ branch. On the other hand, if not treatment successful, then decision 420 branches to the ‘no’ branch. At step 430, the client is invoiced. FIG. 4 processing thereafter ends successfully at 440. The process determines as to whether continue treatment (decision 450). If continue treatment, then decision 450 branches to the ‘yes’ branch which loops back to 410. This looping continues until a decision is made to not continue treatment, at which point decision 450 branches to the ‘no’ branch exiting the loop. There could be many reasons for stopping treatment, such as, for example, when a new medical condition is identified where continued IVS is contraindication. At step 460, the client is not invoiced. FIG. 4 processing thereafter ends with an unsuccessful outcome at 470.

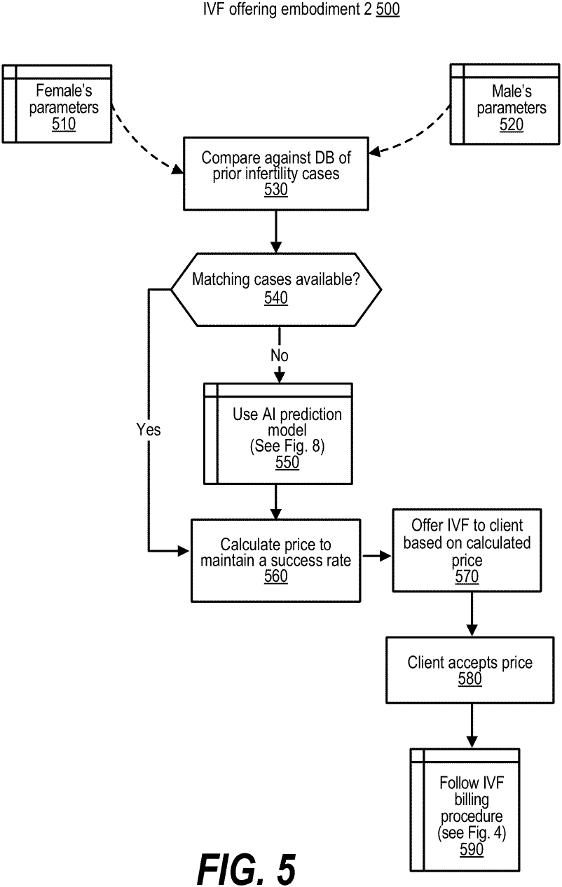

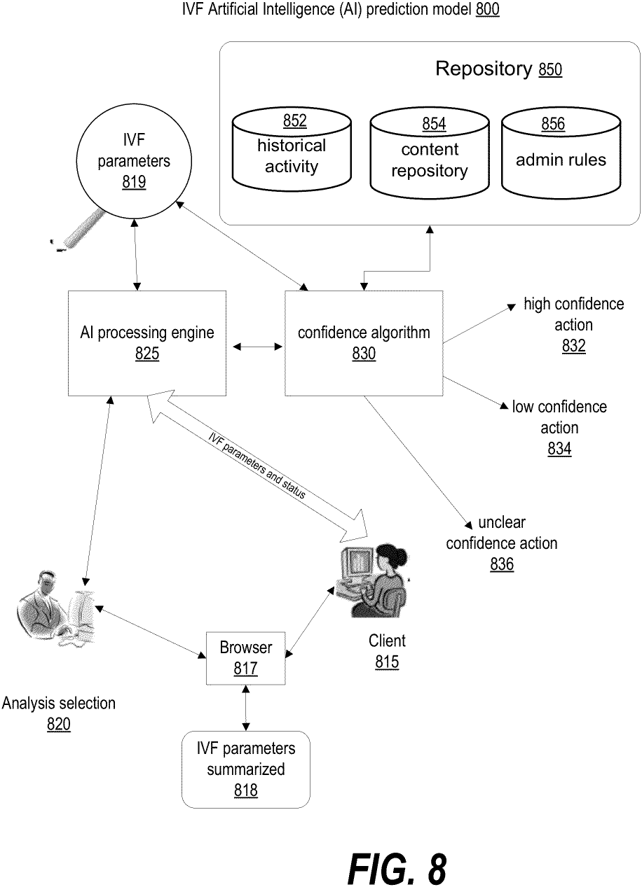

FIG. 5 depicts IVF processing analysis embodiment 2 500. At step 530, the process compares input female’s parameters, such as those identified as entries in 610 and male’s input parameters 520, such as those identified as entries in 630 against a database (DB) of prior infertility case. The process determines as to whether matching cases available (decision 540). If matching cases available, then decision 540 branches to the ‘yes’ branch. On the other hand, if not matching cases available, then decision 540 branches to the ‘no’ branch. At predefined process 550, the process follows AI prediction model (see FIG. 8 and corresponding text for processing details). At step 560, the process calculates price to maintain a success rate. At step 570, the process offers IVF to the client based on the calculated price. At step 580, the client accepts price. At predefined process 590, the process follows IVF billing procedure (see FIG. 4 and corresponding text for processing details).

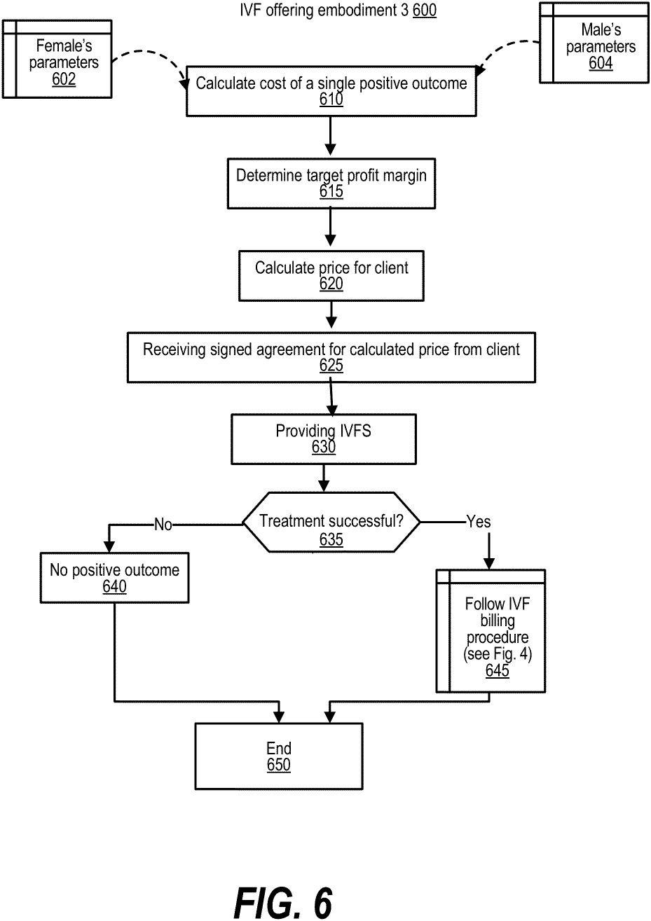

FIG. 6 depicts IVF processing analysis embodiment 3 600. At step 610, the process calculates cost to achieve a single positive outcome using client supplied information. In an embodiment, a probability of success may be determined by infertility case histories using for example, but not limited input female’s parameters 602, such as those identified as entries in 710 and male’s parameters 604, such as those identified as entries in 730, and carrier characteristics. The costs may be calculated from the probability of success. At step 615, the process determines a target profit margin. At step 620, the process calculates price for client which includes the costs plus the target profit margin. At step 625, the process receives signed agreement for calculated price from client. At step 630, IVFS is provided. After a period of time, the process determines as to whether treatment successful (decision 635). If treatment successful, then decision 635 branches to the ‘yes’ branch. On the other hand, if treatment is not successful, then decision 635 branches to the ‘no’ branch. At step 640, the no positive outcome is identified. At predefined process 645, the process follows the IVF billing procedure (see FIG. 4 and corresponding text for processing details). Processing thereafter ends at 650.

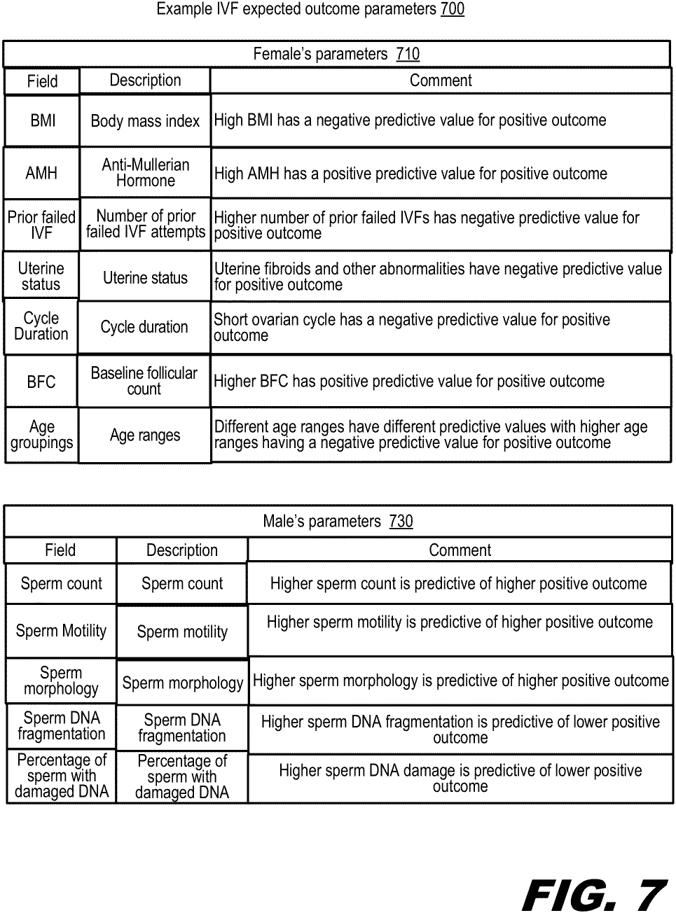

FIG. 7 depicts example IVF expected outcome parameters 700. Example female parameters 710 include: Body mass index (BMI), where high BMI has a negative predictive value for positive outcome. Anti-Mullerian Hormone (AMH), where high AMH has a positive predictive value for positive outcome. Number of prior failed IVF attempts, where a higher number of prior failed IVFs has negative predictive value for positive outcome. Uterine status, where uterine fibroids and other abnormalities have negative predictive value for positive outcome. Cycle duration where short ovarian cycle has a negative predictive value for positive outcome. Baseline follicular count (BFC) where higher BFC has a positive predictive value for positive outcome. Age groupings, that is, age ranges have different predictive values with higher age ranges having a negative predictive value for positive outcome. Example male parameters 730 include: Sperm count, where a higher sperm count is predictive of higher positive outcome. Sperm motility, where a higher sperm motility is predictive of higher positive outcome. Sperm morphology, where a higher sperm morphology is predictive of higher positive outcome. Sperm DNA fragmentation, where a higher sperm DNA fragmentation is predictive of lower positive outcome.

FIG. 8 depicts an embodiment of IVF artificial intelligence (AI) prediction model 800. The prediction model may be used to find matching cases to determine a statistical success rate for a successful outcome of providing IVFS based on client input parameters. Alternatively the prediction model may be used to update predicted costs based on cost analysis when the disclosed method is being used. The IVF parameters 819 are identified for the case. The IVF parameters 819 may be provided by lab tests or by input by the client 815 via any of the communication technologies. It could be, for example, answers to question related to the case and access to lab results by utilizing the browser 817. The repository 850 may be a database management system (DBMS) supporting indexing, queries, and other typical database features. It could be any data store for recording and retrieving data. The repository 850 may include various elements, for example, but not limited to, historical activity 852 that records a history of case studies with new cases added as needed, a content repository 854, that identifies, for example, case studies of previous infertility cases, and admin rules 856 that may determine policies for capturing information, overriding previously entered information, and the like. The repository 850 may have default rules for capturing factors affecting infertility. The repository 850 may be adaptive and may automatically adjust based on feedback via artificial intelligence (AI) technology. Although the user interface depicted in FIG. 8 is browser 817, any user interface may be used. The user interface may provide a GUI where the user inputs parameters as menu entries, command line entries, scripts entries, configuration files, .xml files, or any other means of providing the required information.

In some embodiments, the system may derive the required information from a history of accesses kept by the browser 817. The browser 817 or the search engine used by an analysis selection 820 from other case studies. The system may provide Application Programming Interfaces (APIs) such as a representational state transfer (REST) to support retrieving the browser 817 search history. As the system may keep track of information extracted from the search history to identify matching IVF parameters 819 and determine an initial confidence associated with the identified parameters 819 based on patterns of access and queries. The AI processing engine 825 uses confidence algorithm 830 to access the repository 850 and to characterize the IVF parameters 819. The analysis selection 820 using human feedback may be tied to the confidence algorithm 830 that formulates queries against the repository 850 to determine comparable factors in other case studies. The historical activity 852 may be retrieved as well as the information from the content repository 854 to find associations between a current case and previous case histories. Natural language processing (NLP) may be applied to the historical activity 852, to make the association. Deep analytic analysis and artificial intelligence technologies may be used to adjust the categorization. Feedback from Subject Matter Experts (SMEs), and other user feedback may be used to tune the characterization and form a confidence level or ranking to a previous case study. Selections may be made via analysis selection 820. Human feedback may also be used to tune the IVF parameters summarized 818. The illustrative embodiment is based on a predicted improvement of the case study matching based on the confidence algorithm 830. If the confidence is high that the parameters match a set of case studies, the high confidence action 832 may add the match to the content repository 854. In which case, statistics for the current case may be tracked and added to an existing entry. If the confidence is low, that the parameters match a set of case studies, a low confidence action 834 is taken. The low confidence action 834 may be an indication that no match found. In that case, a new case may be added to the content repository 854. If the confidence is unclear, an unclear confidence action 836 may be taken to request more clarification and the information may be added to the content repository 854 as information to be gathered.

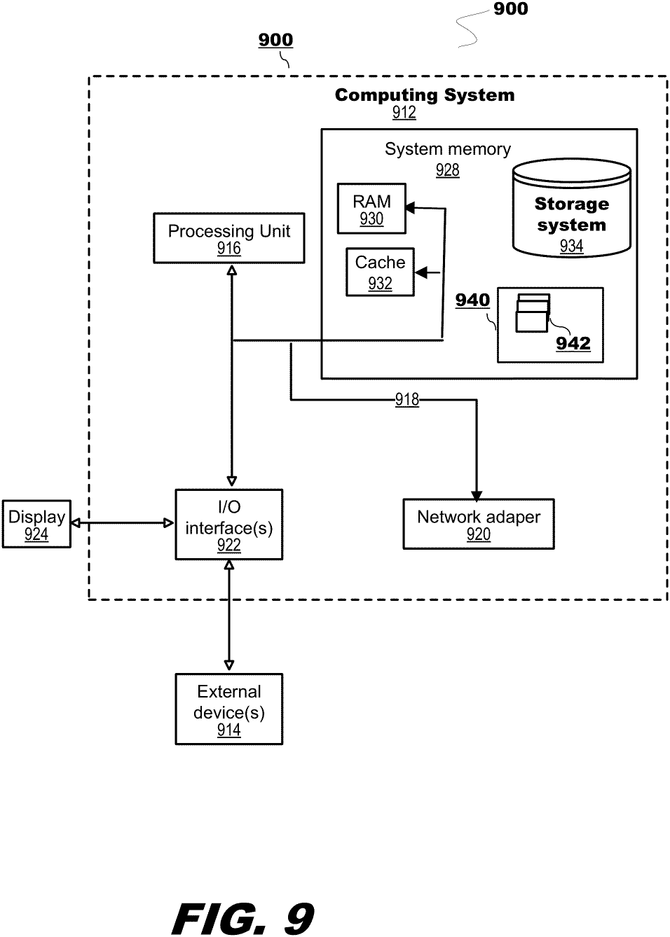

Referring to FIG. 9, a schematic view of a processing system 900 is shown wherein the methods of this invention may be implemented. The processing system 900 is only one example of a suitable system and is not intended to suggest any limitation as to the scope of use or functionality of embodiments of the invention described herein. Regardless, the system 900 can implement and/or performing any of the functionality set forth herein. In the system 900 there is a computer system 912, which is operational with numerous other general purpose or special purpose computing system environments or configurations. Examples of well-known computing systems, environments, and/or configurations that may be suitable for use with the computer system 912 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 912 may be described in the general context of computer system-executable instructions, such as program modules, being executed by a computer system. Generally, program modules may include routines, programs, objects, components, logic, data structures, and so on that perform tasks or implement abstract data types. The computer system 912 may be practiced in distributed cloud computing environments where tasks are performed by remote processing devices that are linked through a communications network. In a distributed cloud computing environment, program modules may be in both local and remote computer system storage media including memory storage devices.

As shown in FIG. 9, the computer system 912 in the system environment 900 is shown in the form of a general-purpose computing device. The components of the computer system 912 may include, but are not limited to, a set of one or more processors or processing units 915, a system memory 928, and a bus 918 that couples various system components including the system memory 928 to the processor 915.

The bus 918 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 912 typically includes a variety of computer system readable media. Such media may be any available media that is accessible by the computer system 912, and it includes both volatile and non-volatile media, removable and non-removable media.

The system memory 928 can include computer system readable media in the form of volatile memory, such as random-access memory (RAM) 930 and/or a cache memory 932. The computer system 912 may further include other removable/non-removable, volatile/non-volatile computer system storage media. By way of example only, a storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 918 by one or more data media interfaces. As will be further depicted and described below, the system memory 928 may include at least one program product having a set (e.g., at least one) of program modules 942 that are configured to carry out the functions of embodiments of the invention.

A program/utility 940, having the set (at least one) of program modules 942, may be stored in the system memory 928 by way of example, and not limitation, as well as an operating system, one or more application programs, other program modules, and program data. Each of the operating systems may have one or more application programs, other program modules, and program data or some combination thereof, and may include an implementation of a networking environment. The program modules 942 generally carry out the functions and/or methodologies of embodiments of the invention as described herein.

The computer system 912 may also communicate with a set of one or more external devices 914 such as a keyboard, a pointing device, a display 924, a tablet, a digital pen, etc. wherein these one or more devices enable a user to interact with the computer system 912; and/or any devices (e.g., network card, modem, etc.) that enable the computer system 912 to communicate with one or more other computing devices. Such communication can occur via Input/Output (I/O) interfaces 922. These include wireless devices and other devices that may be connected to the computer system 912, such as, a USB port, which may be used by a tablet device (not shown). Still yet, the computer system 912 can communicate with one or more networks such as a local area network (LAN), a general wide area network (WAN), and/or a public network (e.g., the Internet) via a network adapter 920. As depicted, a network adapter 920 communicates with the other components of the computer system 912 via the bus 918. It should be understood that although not shown, other hardware and/or software components could be used in conjunction with the computer system 912. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for billing in vitro fertilization services (IVFS) by a provider based on successful outcome comprising:
calculating cost of providing said IVFS to a plurality of clients with predefined parameters over a period of time;
identifying a target profit margin for providing said IVFS to said plurality of clients;
calculating a price to be charged only to clients achieving said successful outcome from the said plurality of clients in order to attain said target profit margin;
receiving by said provider an application from a potential client with said predefined parameters;
offering a contract for said IVFS by said provider to said potential client with payment only due on achievement of said successful outcome based on said price; and
responsive to receiving an acceptance of said contract from said potential client, providing said IVFS to said potential client as a new client based on said contract.

2. The method of claim 1, wherein said cost is calculated by querying a database of historic outcomes for clients with closely related said predefined parameters.

3. The method of claim 1, wherein the successful outcome requires embryo testing for genetic or metabolic competency.

4. The method of claim 1, wherein said client is one of: an individual, a couple, and an entity.

5. The method of claim 4, wherein the entity is selected from a group consisting of a partnership, an insurance carrier, and a third-party agency.

6. The method of claims 1, wherein the provider receives payment for the successful outcome from an escrow account funded by said client.

7. The method of claims 1, wherein the successful outcome is selected from a group consisting of a positive Human Chorionic Gonadotropin (hCG) test, a fetal heartbeat, at least 3 months of pregnancy, delivery of a child, and delivery of a healthy child.

8. The method of claims 1, wherein said predefined parameters are characteristics of gametes sources and intended pregnancy carrier.

9. The method of claim 8, wherein said characteristics are selected from a group consisting of age, Body mass index (BMI), Anti-Mullerian Hormone (AMH), number of prior unsuccessful IVFs, uterine status, cycle duration, baseline follicular count, co-morbidities, sperm characteristics, and carrier demography.

10. Method of claim 8, wherein the said gemetes sources are received from donors.

11. Method of claim 8, wherein the said intended pregnancy carrier is a surrogate mother.

12. The method of claim 1, wherein said contract allows a provider of IVFS to cancel the vitro fertilization services at any time.

13. The method of claim 1, wherein the said payment becomes due before outcome is known if client decides to stop receiving IVFS after the service has been started for non-health related reasons.

14. The method of claims 1, wherein said cost comprises all costs required for IVFS, including medication and services provided by third parties.

15. The method of claims 1, wherein said contract requires said payment from client under a failure to meet agreed to obligations of said client.

16. The method of claim 15 wherein said obligations of said client is selected from a group consisting of a communication frequency, an outcome notification, and an IVS frequency once the said IVFS has been provided.

17. The method of claims 1, wherein IVFS service is selected from a group consisting of IVF, oocyte donation, third party reproduction, and gender selection.

18. A method for billing for in vitro fertilization services (IVFS) based on successful outcome that includes a processor and a memory accessible by the processor, the method comprising:
calculating cost of providing said IVFS to a plurality of clients with predefined parameters over a period of time;
identifying a target profit margin for providing said IVFS to said plurality of clients;
calculating a price to be charged only to clients achieving said successful outcome from the said plurality of clients in order to attain said target profit margin;
receiving by said provider an application from a potential client with said predefined parameters;
offering a contract for said IVFS by said provider to said potential client with payment only due on achievement of said successful outcome based on said price; and
responsive to receiving an acceptance of said contract from said potential client, providing said IVFS to said potential client as a new client based on said contract.

19. An information handling system for billing for in vitro fertilization services based on successful outcome comprising:
one or more processors;
a memory coupled to at least one of the processors;
a network interface that connects the local node to one or more remote nodes; and
a set of computer program instructions stored in the memory and executed by at least one of the processors in order to perform actions comprising:
calculating cost of providing said IVFS to a plurality of clients with predefined parameters over a period of time;
identifying a target profit margin for providing said IVFS to said plurality of clients;
calculating a price to be charged only to clients achieving said successful outcome from the said plurality of clients in order to attain said target profit margin;
receiving by said provider an application from a potential client with said predefined parameters;
offering a contract for said IVFS by said provider to said potential client with payment only due on achievement of said successful outcome based on said price; and
responsive to receiving an acceptance of said contract from said potential client, providing said IVFS to said potential client as a new client based on said contract.

20. A computer program product for billing for in vitro fertilization services based on successful outcome stored in a computer readable storage medium, comprising computer program code that, when executed by the computer program product performs actions comprising:
calculating cost of providing said IVFS to a plurality of clients with predefined parameters over a period of time;
identifying a target profit margin for providing said IVFS to said plurality of clients;
calculating a price to be charged only to clients achieving said successful outcome from the said plurality of clients in order to attain said target profit margin;
receiving by said provider an application from a potential client with said predefined parameters;
offering a contract for said IVFS by said provider to said potential client with payment only due on achievement of said successful outcome based on said price; and
responsive to receiving an acceptance of said contract from said potential client, providing said IVFS to said potential client as a new client based on said contract.
